(19) United States
(12) Patent Application Publication
(10) Pub. No.: US 2020/0144579 A1
(43) Pub. Date: May 7, 2020

(54) ELECTRIFIED VEHICLE WITH LOW PROFILE BUSBAR FOR HIGH CURRENT INTERFACES, AND CORRESPONDING METHOD

(71) Applicant: Ford Global Technologies, LLC, Dearborn, MI (US)

(72) Inventors: Rajesh Narayanan, Canton, MI (US); Francisco Fernandez-Galindo, Canton, MI (US); Darko Acevski, Sterling Heights, MI (US)

(21) Appl. No.: 16/177,675

(22) Filed: Nov. 1, 2018

(51) Int. Cl. H01M 2/20; B60R 16/023; B60L 11/18; H01R 25/16; H01M 2/10; H01M 10/44

(52) U.S. Cl. CPC H01M 2/206; B60R 16/0238; B60L 11/1816; B60K 6/28; H01M 2/1077; H01M 10/441; H01R 25/162

(57) ABSTRACT

This disclosure relates to a low profile busbar for an electrified vehicle and a corresponding method. In a particular embodiment of the electrified vehicle, an example busbar is electrically connected to two electronic components, and the busbar has a cross-section with a height and a width at least 20 times the height. In this way, the width of the busbar is exaggerated relative to the height, giving the busbar a low profile and making the busbar particularly suited for being routed in spaces with reduced packaging height requirements.

### TECHNICAL FIELD

This disclosure relates to a low profile busbar for an electrified vehicle and a corresponding method. In particular, the busbar has an exaggerated width dimension, which in one example is at least 20 times a height of the busbar.

### BACKGROUND

The need to reduce automotive fuel consumption and emissions is well known. Therefore, vehicles are being developed that reduce or completely eliminate reliance on internal combustion engines. Electrified vehicles are one type of vehicle currently being developed for this purpose. In general, electrified vehicles differ from conventional motor vehicles in that they are selectively driven by one or more battery powered electric machines, whereas conventional motor vehicles rely exclusively on the internal combustion engine to drive the vehicle. The various electronic components of electrified vehicles are connected together by way of traditional wires having a circular cross-section or busbars.

### SUMMARY

An electrified vehicle according to an exemplary aspect of the present disclosure includes, among other things, a busbar electrically connected to two electronic components, the busbar having a cross-section with a height and a width at least 20 times the height.

In a further non-limiting embodiment of the foregoing electrified vehicle, the width of the busbar is within a range of 20 to 50 times the height.

In a further non-limiting embodiment of any of the foregoing electrified vehicles, the width of the busbar is about 30 times the height.

In a further non-limiting embodiment of any of the foregoing electrified vehicles, the cross-sectional area of the busbar is within a range of 50 to 100 square millimeters.

In a further non-limiting embodiment of any of the foregoing electrified vehicles, the cross-sectional area of the busbar is about 75 square millimeters.

In a further non-limiting embodiment of any of the foregoing electrified vehicles, the cross-section is substantially rectangular.

In a further non-limiting embodiment of any of the foregoing electrified vehicles, the busbar is a multilayer busbar.

In a further non-limiting embodiment of any of the foregoing electrified vehicles, ends of the busbar are connected to connectors, the connectors are configured to connect to the two electronic components, and the connectors have a reduced width dimension relative to the width of the busbar.

In a further non-limiting embodiment of any of the foregoing electrified vehicles, the connectors include locking tabs.

In a further non-limiting embodiment of any of the foregoing electrified vehicles, the connectors include a hole configured to receive a projection.

In a further non-limiting embodiment of any of the foregoing electrified vehicles, ends of the busbar are configured to connect to wires having a substantially circular cross-section.

In a further non-limiting embodiment of any of the foregoing electrified vehicles, one of the two electronic components is a battery pack, and another of the electronic components is an electronic component external to the battery pack.

In a further non-limiting embodiment of any of the foregoing electrified vehicles, the other of the electronic components is a charging port.

In a further non-limiting embodiment of any of the foregoing electrified vehicles, the two electronic components are arrays of battery cells.

A method according to another exemplary aspect of the present disclosure includes, among other things, electrically connecting two electronic components of an electrified vehicle using a busbar having a cross-section with a height and a width at least 20 times the height.

In a further non-limiting embodiment of the foregoing method, the width of the busbar is within a range of 20 to 50 times the height.

In a further non-limiting embodiment of any of the foregoing methods, the busbar includes connectors adjacent ends thereof having a reduced width dimension relative to the width of the busbar, and the method further includes connecting the connectors to a respective one of the two electronic components.

In a further non-limiting embodiment of any of the foregoing methods, the busbar includes a substantially rectangular cross-section, and the method further includes connecting ends of the busbar to wires having a substantially circular cross-section.

In a further non-limiting embodiment of any of the foregoing methods, the electrically connecting step includes using the busbar to connect a battery pack and an electronic component external to the battery pack.

In a further non-limiting embodiment of any of the foregoing methods, the electrically connecting step includes using the busbar to connect two arrays of battery cells.

### BRIEF DESCRIPTION OF THE DRAWINGS

FIG. 1 schematically illustrates a powertrain of an electrified vehicle.

FIG. 2 illustrates an electrical connection including an example busbar.

FIG. 3 is a cross-sectional view of the example busbar taken along line 3-3 from FIG. 2.

FIG. 4 illustrates an example connector adjacent an end of the busbar. In FIG. 4, the connector includes a first example retention feature.

FIG. 5 illustrates another example connector with a second example retention feature.

### DETAILED DESCRIPTION

This disclosure relates to a low profile busbar for an electrified vehicle and a corresponding method. In a particular embodiment of the electrified vehicle, an example busbar is electrically connected to two electronic components, and the busbar has a cross-section with a height and a width at least 20 times the height. In this way, the width of the busbar is exaggerated relative to the height, giving the busbar a low profile and making the busbar particularly suited for being routed in spaces with reduced packaging height requirements. In other words, the busbar is particularly suited for being routed through vertically narrow spaces. The busbar is also configured to connect high voltage electronic components and to carry relatively high currents, such as those associated with DC fast charging (DCFC). These and other benefits will be appreciated from the following description.

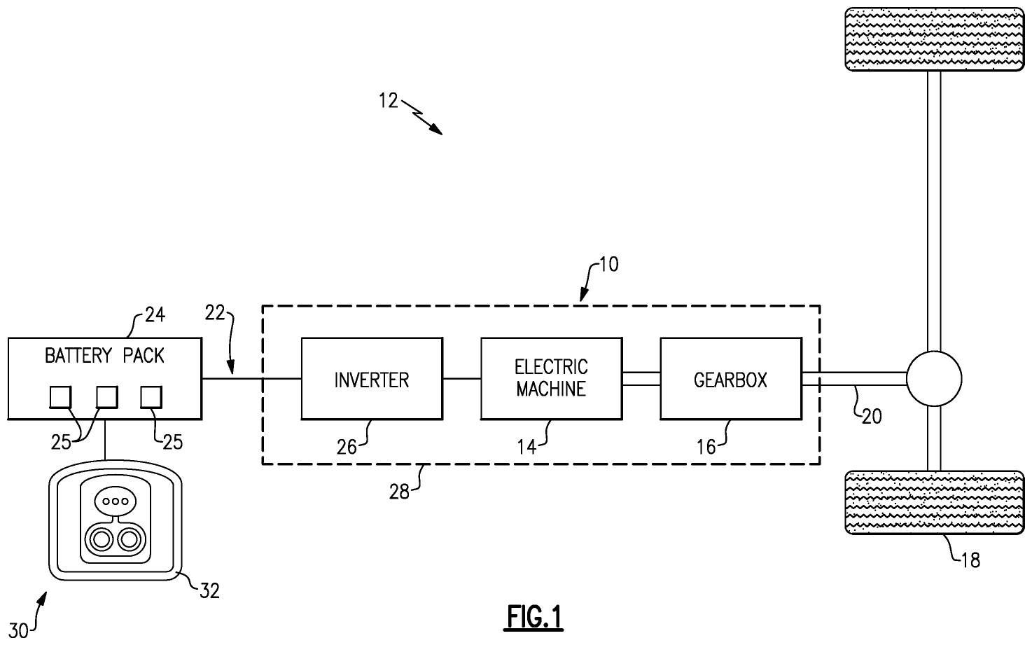

Referring now to the figures, FIG. 1 schematically illustrates a powertrain 10 of an electrified vehicle 12, which is shown as a battery electric vehicle (BEV). Initially, the powertrain 10 shown in FIG. 1 is highly schematic and is not intended to limit this disclosure. Various additional components could alternatively or additionally be employed by the powertrain 10 within the scope of this disclosure. Further, although the electrified vehicle 12 is depicted as a BEV, it should be understood that the concepts described herein are not limited to BEVs and could extend to other electrified vehicles, including but not limited to, plug-in hybrid electric vehicles (PHEVs). Therefore, although not shown in this embodiment, the electrified vehicle 12 could be equipped with an internal combustion engine that can be employed either alone or in combination with other energy sources to propel the electrified vehicle 12. Further, this disclosure extends to any hybrid or electric vehicle including full hybrids, parallel hybrids, series hybrids, mild hybrids, and micro hybrids, among others.

In a non-limiting embodiment, the electrified vehicle 12 is a full electric vehicle propelled solely through electric power, such as by an electric machine 14, without any assistance from an internal combustion engine. The electric machine 14 may operate as an electric motor, an electric generator, or both. The electric machine 14 receives electrical power and provides a rotational output power. The electric machine 14 may be connected to a gearbox 16 for adjusting the output torque and speed of the electric machine 14 by a predetermined gear ratio. The gearbox 16 is connected to a set of drive wheels 18 by an output shaft 20. A high voltage bus 22 electrically connects the electric machine 14 to a battery pack 24 through an inverter 26. The electric machine 14, the gearbox 16, and the inverter 26 may collectively be referred to as a transmission 28.

The battery pack 24 is an energy storage device and, in this example, is an exemplary electrified vehicle battery. In this regard, the battery pack 24 may be referred to as a “battery.” The battery pack 24 may be a high voltage traction battery pack that includes a plurality of battery assemblies 25 (i.e., battery arrays or groupings of battery cells) capable of outputting electrical power to operate the electric machine 14 and/or other electrical loads of the electrified vehicle 12. Other types of energy storage devices and/or output devices can also be used to electrically power the electrified vehicle 12.

The electrified vehicle 12 may also include a charging system 30 for periodically charging the cells of the battery pack 24. The charging system 30 may be connected to an external power source, such as an electrical grid, for receiving and distributing power to the cells. For example, in one non-limiting embodiment, the charging system 30 includes a first interface 32, which is a charging port, located on-board the electrified vehicle 12. The first interface 32 is adapted to selectively receive power from the external power source, such as from a power cable connected to the external power source, and then distribute the power to the battery pack 24 for charging the cells. One example external power source is an electrified vehicle charging station such as a publically available electrified vehicle charging station. In a particular example, the charging station may be a DC fast charging station. In still another example, the electrified vehicle charging station is private, such as those at homes or businesses.

The charging system 30 may also be equipped with power electronics used to convert AC power received from the external power supply to DC power for charging the cells of the battery pack 24. The charging system 30 may also accommodate one or more conventional voltage sources from the external power supply (e.g., 110 volt, 220 volt, etc.).

The powertrain 10 shown in FIG. 1 is highly schematic and is not intended to limit this disclosure. Various additional components could alternatively or additionally be employed within the scope of this disclosure.

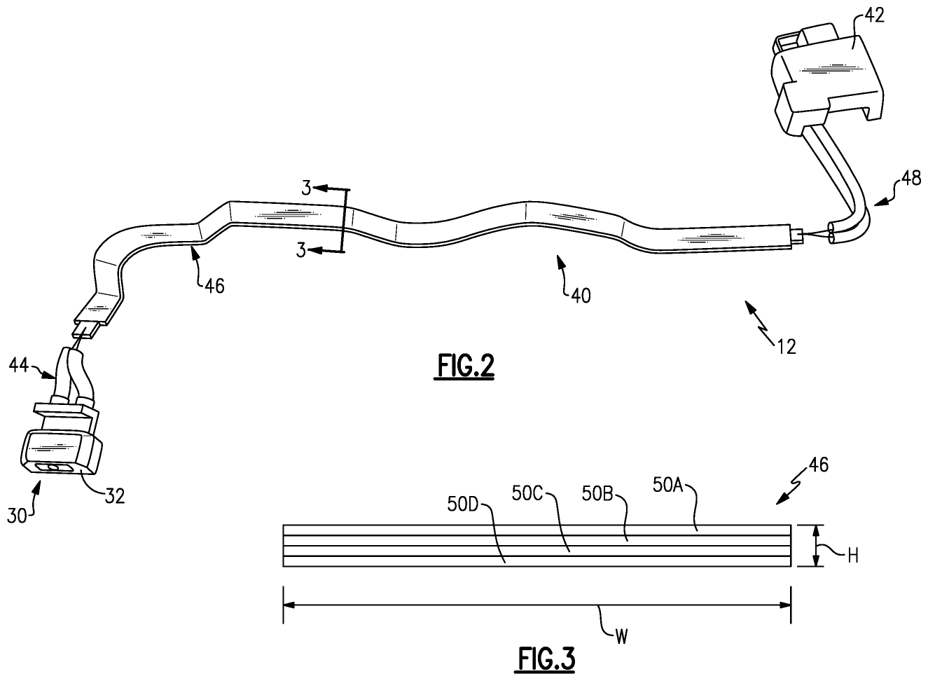

FIG. 2 illustrates an example electrical connection 40 within the electrified vehicle 12. The electrical connection 40 is representative of an electrical connection between two electronic components of the electrified vehicle 12. In the example of FIG. 2, the two electronic components are the first interface 32, or charging port, of the charging system 30, and a second interface 42 which is configured to connect to the battery pack 24.

In this example, beginning at the first interface 32, the electrical connection 40 includes a plurality of wires 44, which may be part of a harness associated with the first interface 32. The wires 44, in this example, are traditional wires which are substantially circular in cross-section. The wires 44 project a relatively short distance from the first interface 32 to a busbar 46, and are electrically connected to the busbar 46 by welding in one example. Here, electrically connected (i.e., electrically coupled) means connected by a conducting path. In another example, the electrical connection 40 does not include the wires 44, and instead the busbar 46 is directly connected to the first interface 32.

The busbar 46 traverses a majority of the distance, if not the entire distance, between the first interface 32 and the second interface 42, which in this example is electrically connected to the battery pack 24. The second interface 42 is electrically connected to the busbar 46 by way of wires 48, which are traditional wires that are substantially circular in cross-section. The wires 48 may be welded to the busbar 46 in one example. The wires 48 need not be present, and it should be understood that this disclosure extends to arrangements where the busbar 46 is connected directly to the second interface 42. Further, while wires 44, 48 are shown, the busbar 46 could be connected to the first and second interfaces 32, 42 using other types of electrical connections.

The electrical connection 40 of FIG. 2 is highly schematic and represents an electrical connection, using the busbar 46, between the battery pack 24 and an electronic component external to the battery pack 24, which in this example is the first interface 32. It should be understood that this disclosure is not limited to electrical connections between the battery pack 24 and the first interface 32, and further extends to connections between electronic components internal to the battery pack 24, such as electrical connections between two battery assemblies 25.

To this end, the electrical connection 40, including the busbar 46, is capable of connecting high voltage electronic components and carrying relatively high currents, such as those associated with DC fast charging (DCFC). For example, the electrical connection 40 of FIG. 2 may be a DCFC connection, wherein a plug from a DCFC charging station is plugged into the first interface 32, and the electrical connection 40 allows relatively high currents to flow to the battery pack 24 to allow for relatively fast charging. The electrical connection 40 may be configured to handle current levels of about 400 Amps, and to allow for power transmission of up to about 400 kW.

The busbar 46 is specially configured to permit such high levels of current and power to flow between the two electronic components, while also being capable of being routed within the electrified vehicle 12. Many spans of the electrified vehicle 12, including those between the first and second interfaces 32, 42, have reduced packaging height requirements, meaning that there are several vertically narrow spaces through which the busbar 46 must pass. Accordingly, in this disclosure, the busbar 46 has an exaggerated (i.e., enlarged or increased) width dimension, which provides the busbar 46 with a unique cross-sectional shape. The cross-sectional shape permits the busbar 46 to be routed within vertically narrow spaces while still being capable of handling relatively high currents.

As shown in FIG. 3, which is a cross-sectional view of the busbar 46 taken along line 3-3 from FIG. 2, the busbar 46 has a substantially rectangular cross-section defined by a height H and a width W. In this example, the width W is at least 20 times the height H, and thus the width W is exaggerated relative to the height H. The busbar 46 has a length sufficient to span the distance between the subject electronic components. Depending on the length of the busbar 46, one or more local attachment points may be needed along the length to reduce vibrations and increase stability.

In this example, the busbar 46 is a multilayer busbar having a plurality of layers 50A-50D of material, which are stacked and/or laminated together to form the busbar 46. Each of the layers 50A-50D individually has the same width W as the busbar 46 overall, and the layers 50A-50D have heights which, when stacked, together provide the busbar 46 with the height H. While four layers 50A-50D are illustrated in FIG. 3, it should be understood that this disclosure extends to busbars having a different number of layers. In other examples, the busbar 46 is not a multilayer busbar, and instead includes a single piece of material having a height H and width W, as shown in FIG. 3.

The busbar 46, in this example, is made of copper (Cu) or aluminum (Al). When the busbar 46 is a multilayer busbar, the layers, such as layers 50A-50D, are also made of copper and/or aluminum.

In order to permit relatively high currents to flow through the busbar 46, the busbar 46 must exhibit a relatively large cross-sectional area, which in one example is within a range of 50 to 100 square millimeters. However, the size of the busbar 46 is also limited by cost and packaging constraints of the electrified vehicle 12. Accordingly, this disclosure provides the busbar 46 with a width W at least 20 times the height H. In a further example, the width W of the busbar 46 is within a range of 20 to 50 times the height H, and may be about 30 times the height H. In the latter example, the width W is constrained on the upper end such that the busbar 46 does not become unduly flimsy. The width W need not be limited at the upper end to 50 times the height H, and one would understand that there is a practical upper limit to the range.

In a further example, the height H of the busbar 46 is 1.65 mm and the width W is about 45 mm, providing the busbar 46 with a cross-sectional area of about 75 square millimeters. The height H of the busbar may be as low as about 1.2 mm in some examples.

Again, these are only examples. Other combinations of height and width dimensions come within the scope of this disclosure. Regardless of the particular dimensions, the busbar 46 exhibits an increased cross-sectional area, thereby making the busbar 46 capable of handling relatively high currents, while also permitting the busbar 46 to be routed through vertically narrow spaces, such as those known to exist between the first and second interfaces 32, 42.

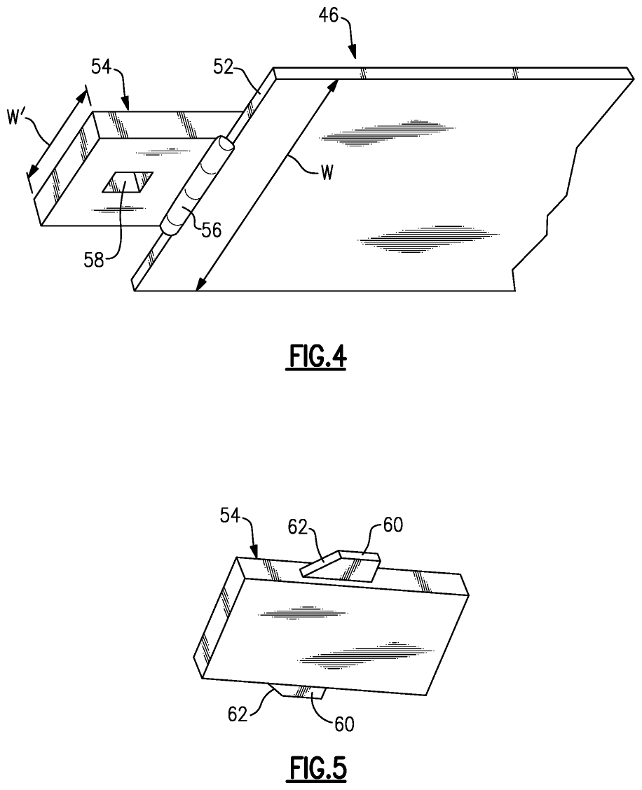

Because of the exaggerated width W, the busbar 46 may not be readily connected to all of the various electronic components of the electrified vehicle 12. Thus, in one aspect of this disclosure, ends 52 of the busbar 46 are connected to connectors 54, as shown in FIGS. 4 and 5. Specifically, FIG. 4 shows one end 52 of the busbar 46 connected to a connector 54 by way of a weld bead 56. The connector 54 is configured to connect directly to electronic components of the electrified vehicle 12, such as the first or second interfaces 32, 42 or the battery assemblies 25. The connector 54 is also configured to connect to traditional wires, either directly or by a connector.

The connector 54 has a reduced width W′ relative to the width W of the busbar 46. The connector 54 may also include one or more retention features configured to facilitate connecting the connector 54 to adjacent electronic components. In FIG. 4, the retention feature is a hole 58 which passes through the connector 54 and is configured to receive a projection from a corresponding electronic component. In FIG. 5, the retention feature is a pair of locking tabs 60 arranged on opposed sides of the connector 54. In this example, the locking tabs 60 include a sloped leading edge 62. The connector 54 may include one, both, or neither of the retention features shown in FIGS. 4 and 5. In other examples, the connector 54 may be welded to form the requisite electrical connection, in addition to the retention features.

It should be understood that terms such as “about” and “substantially” are not intended to be boundaryless terms, and should be interpreted consistent with the way one skilled in the art would interpret those terms.

Although the different examples have the specific components shown in the illustrations, embodiments of this disclosure are not limited to those particular combinations. It is possible to use some of the components or features from one of the examples in combination with features or components from another one of the examples.

One of ordinary skill in this art would understand that the above-described embodiments are exemplary and non-limiting. That is, modifications of this disclosure would come within the scope of the claims. Accordingly, the following claims should be studied to determine their true scope and content.

1. An electrified vehicle, comprising:
a busbar electrically connected to two electronic components, the busbar having a cross-section with a height and a width at least 20 times the height.

2. The electrified vehicle as recited in claim 1, wherein the width of the busbar is within a range of 20 to 50 times the height.

3. The electrified vehicle as recited in claim 2, wherein the width of the busbar is about 30 times the height.

4. The electrified vehicle as recited in claim 1, wherein the cross-sectional area of the busbar is within a range of 50 to 100 square millimeters.

5. The electrified vehicle as recited in claim 4, wherein the cross-sectional area of the busbar is about 75 square millimeters.

6. The electrified vehicle as recited in claim 1, wherein the cross-section is substantially rectangular.

7. The electrified vehicle as recited in claim 1, wherein the busbar is a multilayer busbar.

8. The electrified vehicle as recited in claim 1, wherein:
ends of the busbar are connected to connectors,
the connectors are configured to connect to the two electronic components, and
the connectors have a reduced width dimension relative to the width of the busbar.

9. The electrified vehicle as recited in claim 8, wherein the connectors include locking tabs.

10. The electrified vehicle as recited in claim 8, wherein the connectors include a hole configured to receive a projection.

11. The electrified vehicle as recited in claim 1, wherein ends of the busbar are configured to connect to wires having a substantially circular cross-section.

12. The electrified vehicle as recited in claim 1, wherein one of the two electronic components is a battery pack, and wherein another of the electronic components is an electronic component external to the battery pack.

13. The electrified vehicle as recited in claim 12, wherein the other of the electronic components is a charging port.

14. The electrified vehicle as recited in claim 1, wherein the two electronic components are arrays of battery cells.

15. A method, comprising:
electrically connecting two electronic components of an electrified vehicle using a busbar having a cross-section with a height and a width at least 20 times the height.

16. The method as recited in claim 15, wherein the width of the busbar is within a range of 20 to 50 times the height.

17. The method as recited in claim 15, wherein the busbar includes connectors adjacent ends thereof having a reduced width dimension relative to the width of the busbar, and further comprising connecting the connectors to a respective one of the two electronic components.

18. The method as recited in claim 15, wherein the busbar includes a substantially rectangular cross-section, and further comprising connecting ends of the busbar to wires having a substantially circular cross-section.

19. The method as recited in claim 15, wherein the electrically connecting step includes using the busbar to connect a battery pack and an electronic component external to the battery pack.

20. The method as recited in claim 15, wherein the electrically connecting step includes using the busbar to connect two arrays of battery cells.
